(19) United States
(12) Patent Application Publication
(10) Pub. No.: US 2024/0347813 A1
(43) Pub. Date: Oct. 17, 2024

(54) HYBRID THERMAL MANAGEMENT SYSTEM

(71) Applicant: DEERE & COMPANY, Moline, IL (US)

(72) Inventors: Alan D. Sheidler, Moline, IL (US); Thomas L. Kennedy, Bettendorf, IA (US); Paul I. Craig, Thibodaux, LA (US); Prabhdeep Virk, Davenport, IA (US); Zachary T. Eichelberger, East Moline, IL (US)

(21) Appl. No.: 18/301,601

(22) Filed: Apr. 17, 2023

(51) Int. Cl. H01M 10/6569; B60H 1/00; H01M 10/613; H01M 10/6556

(52) U.S. Cl. CPC H01M 10/6569; B60H 1/004; H01M 10/613; H01M 10/6556; B60H 2001/00307; H01M 2220/20

(57) ABSTRACT

A thermal management system configured for use with electric engines, including hybrid electric engines, may include at least three cooling circuits. A first cooling fluid can have a first cooling fluid including a dielectric thermal fluid and can be positioned to directly remove heat from one or more batteries. A second cooling circuit can be directly thermally coupled to the first cooling circuit, and a third cooling circuit can be directly thermally coupled to the second cooling circuit. A second cooling fluid of the second cooling circuit can be an electrically conductive cooling fluid or a refrigerant, and a third cooling fluid of the third cooling circuit can be the other of the electrically conductive cooling fluid and the refrigerant. The second or third cooling circuit can be positioned to directly remove heat from one or more electronic units that are electrically coupled to the one or more batteries.

### FIELD OF THE DISCLOSURE

The present disclosure generally relates to a thermal management system, and, more specifically, to a thermal management system for an electric engine that utilizes a dielectric thermal fluid.

### BACKGROUND

Hybrid electric engines typically operate using a combination of a fuel and electrical energy as sources of power for engine operation. Moreover, hybrid engines can combine features of an internal combustion engine and an electrically powered engine in generating a force, such as a force used with at least propulsion of an associated vehicle. Thus, power for hybrid engines can be generated by combustion of a fuel, including, but not limited to, petroleum and diesel fuel, as well as by use of power stored in one or more batteries, including battery packs.

Whether utilized with hybrid electric engines or electric engines, operation of associated battery systems, and, moreover, the battery(ies) of the battery system, can generate heat. If not controlled, such generated heat can be detrimental to the operation or efficiency of at least the battery. Additionally, certain electronic devices utilized in connection with the management, conversion, or use of electrical power generated and stored by such battery systems, among other systems, can also generate heat that, if not controlled, can also be detrimental to the operation of those electronic devices.

The types of cooling mediums used for different aspects of hybrid electric engines, as well the operating temperatures for different systems or components of such hybrid electric engines, can vary. Such variances can increase the complexity, and thus the associated costs, of the cooling systems for hybrid electric engines. Further, in many applications, available space, and the size of such available spaces, within an area or compartment in which such cooling systems are to be located can be limited. Accordingly, thermal management systems for battery systems used with to electric engines, including hybrid electric engines, remains an area of interest.

### SUMMARY

The present disclosure may comprise one or more of the following features and combinations thereof.

In one embodiment of the present disclosure, a thermal management system is provided that includes a first cooling circuit that can be configured to circulate a first cooling fluid, the first cooling fluid comprising a dielectric thermal fluid, the first cooling circuit including one or more batteries. The thermal management system can also include a second cooling circuit configured that can circulate a second cooling fluid, the second cooling circuit being directly thermally coupled to the first cooling circuit such that a heat entrained in the first cooling fluid is transferable to the second cooling fluid. Additionally, the thermal management system can also include a third cooling circuit that can be configured to circulate a third cooling fluid, the third cooling circuit being directly thermally coupled to the second cooling circuit such that a heat entrained in the second cooling fluid is transferable to the third cooling fluid. Further, the second cooling fluid is an electrically conductive cooling fluid or a refrigerant, and the third cooling fluid being the other of the electrically conductive cooling fluid and the refrigerant.

In another embodiment, a thermal management system is provided that includes a hybrid diesel engine, at least one electronic unit, and at least one battery. The thermal management system can include a first cooling circuit that can be configured to circulate a first cooling fluid, the first cooling fluid comprising a dielectric thermal fluid, the first cooling circuit positioned to remove heat from the at least one battery. The thermal management system also include a second cooling circuit that can be configured to circulate a second cooling fluid, the second cooling circuit being directly thermally coupled to the first cooling circuit such that heat entrained in the first cooling fluid is absorbed by the second cooling fluid. Additionally, the thermal management system can include a third cooling circuit that can be configured to circulate a third cooling fluid, the third cooling circuit being directly thermally coupled to the second cooling circuit such that heat entrained in the second cooling fluid is absorbed by the third cooling fluid. Further, the second cooling fluid can be an electrically conductive cooling fluid or a refrigerant, and the third cooling fluid being the other of the electrically conductive cooling fluid and the refrigerant. Additionally, the second cooling circuit or the third cooling circuit is positioned to remove heat from the at least one electronic unit, and a portion of the second cooling circuit or the third cooling circuit can be positioned to be air cooled by a fan that is operable by the hybrid diesel engine.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a first embodiment of a hybrid thermal management system.

FIG. 2 illustrates an exemplary variation of the first embodiment of a hybrid thermal management system shown in FIG. 1.

FIG. 3 illustrates a second embodiment of a hybrid thermal management system.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

A number of features described below may be illustrated in the drawings in phantom. Depiction of certain features in phantom is intended to convey that those features may be hidden or present in one or more embodiments, while not necessarily present in other embodiments. Additionally, in the one or more embodiments in which those features may be present, illustration of the features in phantom is intended to convey that the features may have location(s) and/or position(s) different from the locations(s) and/or position(s) shown.

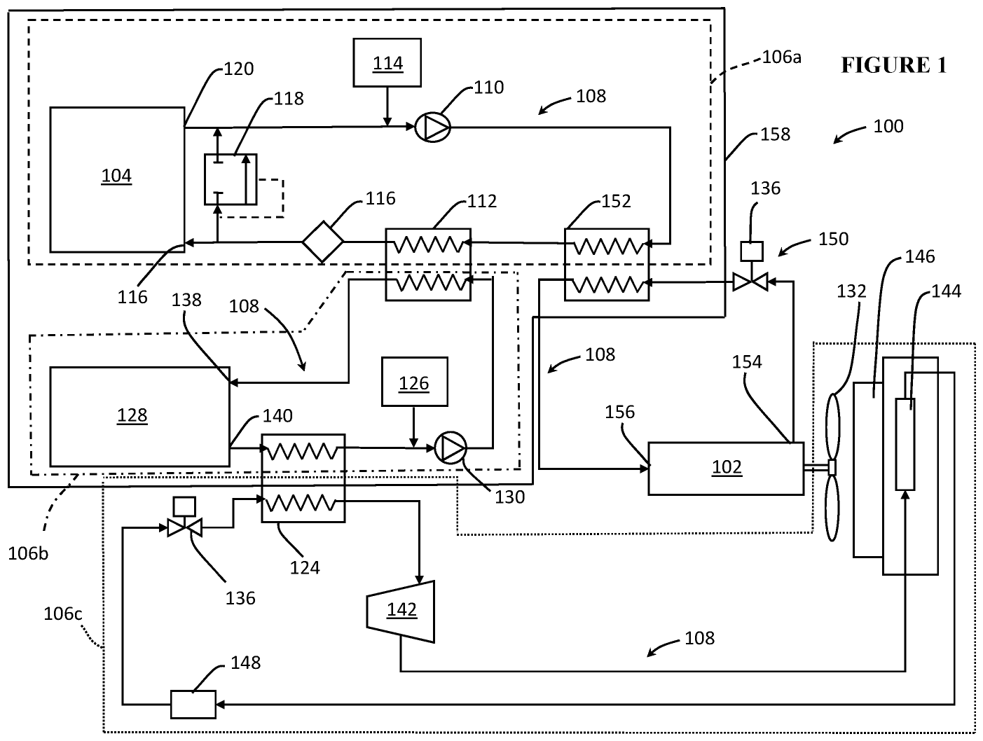

FIG. 1 illustrates a first embodiment of a hybrid thermal management system 100. According to the illustrated embodiment, the hybrid thermal management system 100 is utilized with an engine 102 and one or more batteries or a battery pack (collectively referred to herein as battery 104). While FIG. 1 illustrates a particular arrangement of components of the hybrid thermal management system 100, the system 100 can have fewer or more components than those illustrated in FIG. 1. Additionally, the types and arrangements of components of the hybrid thermal management system 100 can also vary for other systems.

According to certain embodiments, the engine 102 is a hybrid engine 102 that is at least partially powered by electrical energy stored by the battery 104. For example, the engine 102 can comprise a hybrid diesel engine, including, but not limited to, a hybrid diesel engine that is utilized to at least assist with providing power for forward propulsion or travel of an agricultural machine or equipment. The battery 104 can assist in storing electrical energy that can be utilized to support motoring of the engine 102, as well as in connection storing electrical energy that can be generated at least in part by operation of the engine 102. While a variety of different types of batteries can be utilized, according to certain embodiments, the battery 104 is configured to utilize dielectric thermal fluid to control temperatures of the battery 104, including the temperature(s) of battery cells within the battery 104. Moreover, according to certain embodiments, the battery 104 is not configured to utilize either or both air or a glycol (including a glycol based) cooling fluid or medium in connection with cooling or managing internal battery cell temperature(s) of the battery 104, or other internal cooling within a housing of the battery 104.

The hybrid thermal management system 100 shown in FIG. 1 utilizes at least three heat transfer, or cooling, loops or circuits 106a-c, each cooling circuit 106a-c using a different heat transfer fluid or medium (referred to herein as cooling fluid). Additionally, the first cooling circuit 106a can be thermally coupled to the second cooling circuit 106b, which is also thermally coupled to the third cooling circuit 106b. Such a configuration can accommodate heat being indirectly transferred from the battery 104, via the first cooling circuit 106a, to the third cooling circuit 106c via the intermediate secondary cooling circuit 106b, as discussed below. The cooling fluid within each of the three cooling circuits 106a-c can be transported within the cooling circuit 106a-c, as well as between, and, optionally, within, components of the cooling circuits 106a-c through a variety of types of conduits, tubes, or pipes, as well as combinations thereof, as well as associated fittings, collectively generally referred to herein as a conduit 108.

According to certain embodiments, the first cooling circuit 106a can utilize a first cooling fluid that is a dielectric thermal liquid, and which is not air or another gas. Moreover, the first cooling fluid is a liquid that can be utilized to remove heat from the battery 104, including, for example, from another cooling fluid or medium within the battery 104, while also being electrically non-conductive. By being electrically non-conductive, the first cooling fluid may not cause electrical short circuiting across at least the first cooling circuit 106, or the associated components of the first cooling circuit 106a, and instead may generally be an electric insulator. The first cooling fluid can also have a relatively high thermal conductivity and relatively low viscosity, which can assist in the first cooling fluid being circulated about the first cooling circuit 106a. For example, according to certain embodiments, the first cooling fluid can be mineral oil, as well as various commercially available dielectric thermal fluids, among other dielectric liquids. Thus, according to the illustrated embodiment, the first cooling circuit 106a is a dielectric fluid cooling circuit, and can also be referred to as a battery cooling circuit.

Unlike the first cooling circuit 106a, the second cooling circuit 106b can utilize a second cooling fluid that is electrically conductive, particularly relative to the first cooling fluid. For example, according to certain embodiments, the second cooling fluid can include either, or a mixture of, water or glycol, among other conductive fluids. Thus, the second cooling fluid can, for example, be a water and/or glycol based cooling liquid. The second cooling circuit 106b can therefore be referred to as a conductive fluid cooling circuit.

The third cooling circuit 106c is a vapor-compression refrigerant circuit, or a refrigerant circuit, that is adapted to compress a heated refrigerant that is circulated through the third cooling circuit 106c, as well as utilize a condenser to cool the heated refrigerant. Thus, according to certain embodiments, the refrigerant can change between liquid and gaseous forms. According to certain embodiments, the third cooling fluid of the third cooling circuit 106c is a refrigerant, such as, for example, R134a and 1234yf, among other refrigerants.

According to the illustrated embodiment, the first cooling circuit 106a, or dielectric fluid cooling circuit, can include the battery 104, at least one first pump 110, and at least one first heat exchanger or chiller 112. The first pump 110 is configured to provide a force that is directly or indirectly imparted onto at least a portion of the first cooling fluid in a manner that facilitates circulation of the first cooling fluid about the first cooling circuit 106a. As discussed below, the first heat exchanger 112 is also coupled to the second cooling circuit 106 such that at least a portion of the heat entrained in the first cooling fluid can be transferred to the second cooling fluid. Thus, according to certain embodiments, the first heat exchanger 112 can be a liquid-to-liquid type heat exchanger.

Optionally, or additionally, the first cooling circuit 106a can include a first reservoir 114 for the first cooling fluid, a filter 116, and a pressure relief valve 118. The filter 116 can be configured to remove debris or other materials that may collect in the first cooling fluid. The first reservoir 114 can be adapted to at least assist in maintaining a certain level of first cooling circuit 106a flowing through the first cooling circuit 106a. Thus, according to certain embodiments, to the extent necessary, the first reservoir 114 can assist in replenishing at least a portion of first cooling fluid that is circulating through the conduits 108. Additionally, or alternatively, to the extent needed, the first reservoir 114 can also provide an outlet for a flow, including an overflow, of first cooling fluid or associated gases that may be at least occasionally present within at least a portion of the first cooling circuit 106a as the first cooling fluid is heated or overheated.

For at least purposes of discussion, as indicated by FIG. 1, according to certain embodiments, the first pump 110 can be located downstream of a coolant outlet 120 of the battery 104. Further, in the illustrated embodiment, at least one first heat exchanger 112 can be positioned between the first pump 110 and a coolant inlet 122 of the battery 104. FIG. 1 also depicts the filter 116 being positioned between the first heat exchanger 112 and the coolant inlet 122 of the battery 104. Additionally, the pressure relief valve 118 is depicted as being positioned to provide a bypass between the coolant inlet 122 and coolant outlet 120 of the battery 104.

Thus, according to illustrated embodiment, operation of the first pump 110 can facilitate circulation of the first cooling fluid such that heated first cooling fluid exits the coolant outlet 120 of the battery 104 and can at least be circulated to, and through, the first heat exchanger 112. At least a portion of the heat entrained in the heated first cooling fluid can then be removed from the first cooling fluid before the first cooling fluid passes through the filter 116 and into the coolant inlet 122 of the battery 104. According to certain embodiments, the first heat exchanger 112, and associated flow of the second cooling fluid therein, can be configured to reduce the temperature of the first cooling fluid to a level that the first cooling fluid can at least assist in maintaining either or both the battery cells or other cooling fluid or medium within the battery 104 to a temperature of around 10 degrees Celsius (° C.) to around 40° C.

The second cooling circuit 106b, or conductive fluid cooling circuit, can also include the first heat exchanger 112 such that heat entrained in the first cooling fluid can be transferred to the second cooling fluid. Thus, according to the illustrated embodiment, the first heat exchanger 112 can be utilized to decrease the temperature of the first cooling fluid and increase the temperature of the second cooling fluid.

The second cooling circuit 106b can also include one or more second heat exchangers or chillers 124 that is/are also part of the third cooling circuit 106c and configured to transfer heat from the second cooling fluid to the third cooling fluid. While a variety of types of heat exchangers can be utilized for the second heat exchanger 124, according to an exemplary embodiments, the second heat exchanger 124 is a brazed plate heat exchanger. Such a configuration can permit the second cooling fluid to be cooled within the second cooling circuit 106b without the second cooling circuit 106b having a radiator, or other air cooler, for the second cooling fluid.

The second cooling circuit 106b can also include one or more second pumps 130 and a second reservoir 126 for the second cooling fluid. The second pump 130 is utilized to provide a force to circulate the second cooling fluid through the second cooling circuit 106b. The second reservoir 126 can provide an outlet for a flow, including an overflow, of second cooling fluid or associated gases that may be at least occasionally present within at least a portion of the second cooling circuit 106b as the second cooling fluid is heated or overheated.

The second cooling circuit 106b can further include one or more electronic units 128. For example, according to certain embodiments, the electronic unit 128 can comprise one or more of either, or both, an inverter or a converter, among other electronic units that can be electrically coupled to at least the battery 104. Thus, according to the illustrated embodiment, the electronic unit 128 can be an inverter that inverts direct current (DC) stored by the battery 104 into alternating current (AC), including three phase AC current. The electronic unit 128 can also be, but is not limited to, an electronic control unit (ECU), or one or more other electronic devices of the engine 102. Additionally, according to certain embodiments, the electronic unit 128 can be utilized to control the operation of one or more components of the system 100, including for example, pumps 110, 130, an impeller or fan 132, and/or an actuator or solenoid for opening/closing valves 134, 136, among other components of the system 100. Additionally, or alternatively, the operation of components of the system 100, including, for example, the valves 134, 136 and pumps 110, 130 can also be controlled by a battery management system. Further, as discussed below, whether the second cooling circuit 106b is being operated in connection with cooling the first cooling fluid of the first control circuit 106a can be controlled by the ECU or the battery management system.

As illustrated, the electronic unit 128 can be downstream from the first heat exchanger 128 such that the temperature of the second cooling fluid entering the electronic device is higher than the temperature of the second cooling fluid that is entering the first heat exchanger 128. Thus, according to the depicted embodiment, the second cooling fluid can flow from the first heat exchanger 112 to a coolant inlet 138 of the electronic unit 128, wherein heat generated by the operation of the electronic unit 128 can be transferred to the second cooling fluid. According to certain embodiments, at least the second cooling circuit 106b is configured such that the second cooling fluid can assist in maintaining the temperature of the electronic device at around 70° C. The heated second cooling fluid can flow from a coolant outlet 140 of the electronic unit 128 and to the second heat exchanger 124, wherein heat entrained in the second cooling fluid can be transferred to the third cooling fluid. Further, as previously mentioned, such flow of the second cooling fluid can be facilitated, at least in part, by a force directly or indirectly imparted onto the second cooling fluid by operation of the second pump 130.

The illustrated third cooling circuit 106c can include the second heat exchanger 124, a compressor 142, and a condenser 144. As shown, liquid third cooling fluid is heated via absorbing heat from the second cooling fluid at the second heat exchanger 124, thereby converting the heated third cooling fluid from a liquid to a low pressure gas. The low pressure gas can then be compressed by the compressor 142, wherein the third cooling fluid is converted to a high pressure gas. The third cooling fluid can then flow to the condenser 144, wherein heat can be removed from the high pressure gaseous third cooling fluid, thereby allowing the gascous third cooling fluid to return to a liquid state. Further, according to certain embodiments, the condenser 144, as well as a radiator 146 of the engine 102, can be cooled by a flow of air that is being propelled by a fan 132 that is rotated via operation of the engine 102. Thus, according to the illustrated embodiment, the condenser 144 is air cooled, including, for example, via convection.

Optionally, or additionally, the third cooling circuit 106c can include one or more valves 134 and a filter dryer 148. According to certain embodiments, the valve 134 can be an expansion valve or a solenoid valve. Further, the filter dryer 148 can be configured to capture particulate contaminants that may be in the third cooling fluid, as well as capture moisture in the third cooling fluid. Additionally, as seen in FIG. 1, according to the illustrated embodiment the valve 134 and filter dryer 148 can be positioned between the condenser 144 and the second heat exchanger 124.

The compressor 142 can be utilized for cooling control of the thermal management system 100. More specifically, activation and deactivation of the compressor 142 can control whether the third cooling fluid is being cooled. If the third cooling fluid is not being cooled, the third cooling fluid may not, or may minimally, absorb heat from the second cooling fluid at the second heat exchanger 124, thereby resulting in the second cooling fluid remaining at a heated or elevated temperature. Similarly, if the second cooling fluid is maintained at a heated or elevated temperature, the first cooling fluid may not be cooled, or may be minimally cooled, by the second cooling fluid at the first heat exchanger 112, thereby retaining the first cooling fluid at a heated or elevated temperature. Accordingly, activation or deactivation of the compressor 142 can also control whether the first and second cooling fluids of the first and second cooling circuits 106a, 106b, respectively, are, or are not, being cooled. According to certain embodiments, activation/deactivation of the compressor 142 can be controlled by turning the power supply to the compressor 142 on or off. Further, such activation and deactivation of the compressor 142 can be controlled in a variety of manners, including, for example, by the ECU or a battery management system. Additionally, such an arrangement can accommodate the first cooling circuit 106a being operated without the first cooling circuit 106a having any valves.

Thus, when the compressor 142 is activated, at least a portion of the heat removed from the battery 104 via the first, dielectric cooling fluid of the first cooling circuit 106a can be transferred to the second, conductive cooling fluid of the second cooling circuit 106b via the first heat exchanger 112. The heated second cooling fluid can then flow through the electronic unit 128 before flowing to the second heat exchanger 124, wherein at least a portion of the heat in the second cooling fluid can be transferred to heat the third, refrigerant cooling fluid of the third cooling circuit 106c. After being compressed to a higher pressure, heat contained in the third, refrigerant cooling fluid can be released at the air-cooled condenser 144.

The thermal management system 100 provides a manner of cooling the second, conductive cooling fluid of the second cooling circuit 106b without the second cooling circuit 106b having a dedicated radiator. The ability of the system 100 to operate without the need for a radiator that is dedicated to the second cooling fluid can provide a number of benefits. For example, the absence of such a dedicated radiator, as well as the absence of valves in the first cooling circuit 106a, can reduce the number of components for the system 100, which can provide time and costs savings in terms of manufacturing, assembling, and installing of the system 100. Further, compared to traditional systems, the system 100 can also have a smaller footprint or space requirements. Smaller space requirements can be beneficial at least with respect to providing greater flexibility in terms of the locations at which the thermal management system 100 can be positioned in an associated engine compartment with the engine 102.

For example, the thermal management system 100 can be constructed to maintain fuel cells and/or internal cooling fluid of the battery 102, as well as the electronic unit(s) 128, at temperatures that are lower than ambient temperatures. The smaller footprint or space requirement of the thermal management system 100 can be beneficial with respect to spaces in an engine compartment that can accommodate placement of the system 100 at a location at which the first and second circuits 106a, 106b are, compared to traditional systems, further from the hot operating engine 102. Such configurations can also provide flexibility in that the third cooling circuit 106c can be positioned closer than the first and second cooling circuits 106a, 106b to the hot operating engine 102. Moreover, the refrigerant discussed above for use as the third cooling fluid often is at a temperature that is higher than ambient temperatures, which can accommodate the third cooling circuit 106c being capable of being positioned in closer proximity to a hot operating engine 106 than the other cooling circuits 106a, 106b.

Additionally, with such embodiments, the first and second cooling loops 106a, 106b, including the battery 104 and the electronic unit 128, can be housed together in a housing 158 that may not include at least a portion of the third cooling circuit 106c, which may minimize environmental heat absorption by those components. For example, according to certain embodiments, the housing 158 may not include one or more of the compressor 142, condenser 144, or filter dryer 148. Further, by being able to accommodate the battery 104 and electronic unit(s) 128 being packaged together, the thermal management system 100 provide reductions in the lengths of the conduits 108 of the first and second cooling circuits 106a, 106b. Such reductions in the length of conduit 108 can be particularly beneficial with respect to environmental heat transfer involving the second cooling fluid, including with respect to glycerol or glycerol based coolants.

The exemplary hybrid thermal management system 100 shown in FIG. 1 also includes a heating circuit 150. The heating circuit 150 can be adapted to selectively utilize heat entrained in the first, dielectric cooling fluid to an operating fluid, such as, for example, engine coolant or engine oil for the engine 102. According to the illustrated embodiment, the heating circuit 150 can include a third heat exchanger 152, which can be part of the first cooling circuit 106a. As seen in FIG. 1, with respect to the first cooling circuit 106a, the third heat exchanger 152 is positioned upstream of the first heat exchanger 112 such that heated first cooling fluid flows through the third heat exchanger 152 to heat the operating fluid before the first cooling fluid is further cooled at the first heat exchanger 112. According to certain embodiments, cool operating fluid can flow from a fluid outlet 154 of the engine 102, through a control valve 136 and the third heat exchanger 152, wherein the operating fluid is heated before being delivered to the fluid inlet 156 of the engine 102. According to certain embodiments, aside from the control valve 136 being at least temporarily opened in certain operating conditions, including for example, with respect to starting the engine 102 in cold environments, the control valve 136 can normally be in a closed position such that operating fluid is not being circulated through the heating circuit 150.

Alternatively, according to certain embodiments, rather than the third heat exchanger 152 being used with the first cooling loop 106c, the third heat exchanger 152 can be positioned along the second cooling loop 106b, or the third cooling loop 106c. For example, if positioned about the second cooling loop 106b, heated second cooling fluid, such as, for example, glycerol, can be used to provide heat that is transferred, via the third heat exchanger 152, to the operating fluid. Additionally, according to such embodiments, the second cooling loop 106b can include a valve, such as, for example, a two way valve, that can divert a portion of the hot second cooling fluid exiting the electronic unit 128 or the first heat exchanger 112 to the third heat exchanger 152, while another portion of the second cooling fluid is directed to either the second heat exchanger 124 or the electronic unit 128, respectively. According to such an embodiment, the portion of the second cooling fluid that was diverted to the third heat exchanger 152 can subsequently be directed to the first heat exchanger 112, or rejoin second cooling fluid that was heated in the first heat exchanger 112 before being delivered to the electronic unit 128.

Thus, for example, when the operating fluid is to be heated via use of the heating circuit 150, the ECU or battery management system can open the control valve 136 of the heating circuit 150 and can deactivate, or not activate, the compressor 142. In such a situation, the associated effect of having non-cooled, or heated second cooling fluid can result in the first cooling fluid being at a temperature that, when the first cooling fluid reaches the third heat exchanger 152, elevates the temperature of the operating fluid. However, in typical situations, the ECU or battery management system is automatically controlling the activation or deactivation of the compressor 142 based on the temperature or cooling needs of the battery 104, which can, for example, be determined using either or both an internal battery temperature of the battery 104 or a temperature of the first cooling fluid of the first cooling loop 106a.

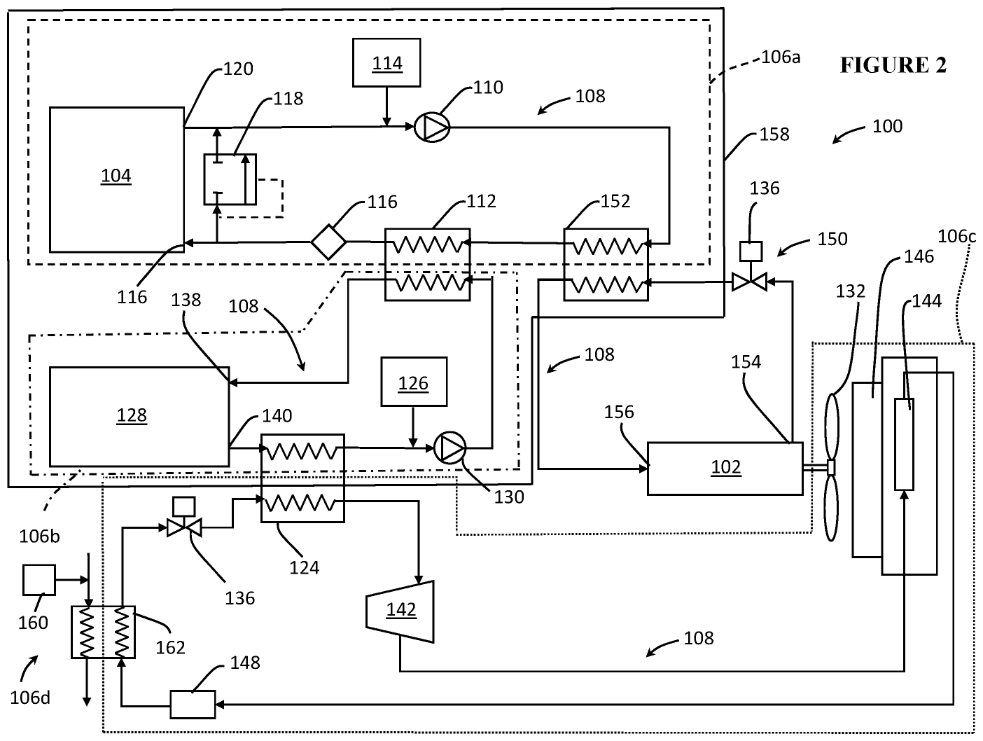

While the thermal management system 100 is discussed above with respect to having three cooling circuits 106a-c, the system 100 can be configured to include additional cooling circuits that may, or may not, be directed to other systems or devices, including, for example, other systems of a motorized machine or equipment. For example, referencing FIG. 2. according to certain embodiments, the thermal management system 100 can include at least one additional cooling circuit 106d that can be utilized to control a temperature of a fuel, such as, for example, a diesel fuel, of a fuel system. Additionally, or alternatively, the thermal management system 100 can include one or more other cooling circuits 106d that are utilized in connection with controlling a temperature of an aspect of an exhaust system. For example, the thermal management system 100 can include a fourth cooling circuit 106d that is used in connection with cooling a diesel exhaust fluid (DEF) that may be injected by an injector 160 into an exhaust gas stream. According to such embodiments, the additional cooling circuit 106d can have a heat exchanger 162, including, but not limited to, a brazed plate heat exchanger, that can also be incorporated into one of the above-discussed first, second, or third cooling circuits 106a-c.

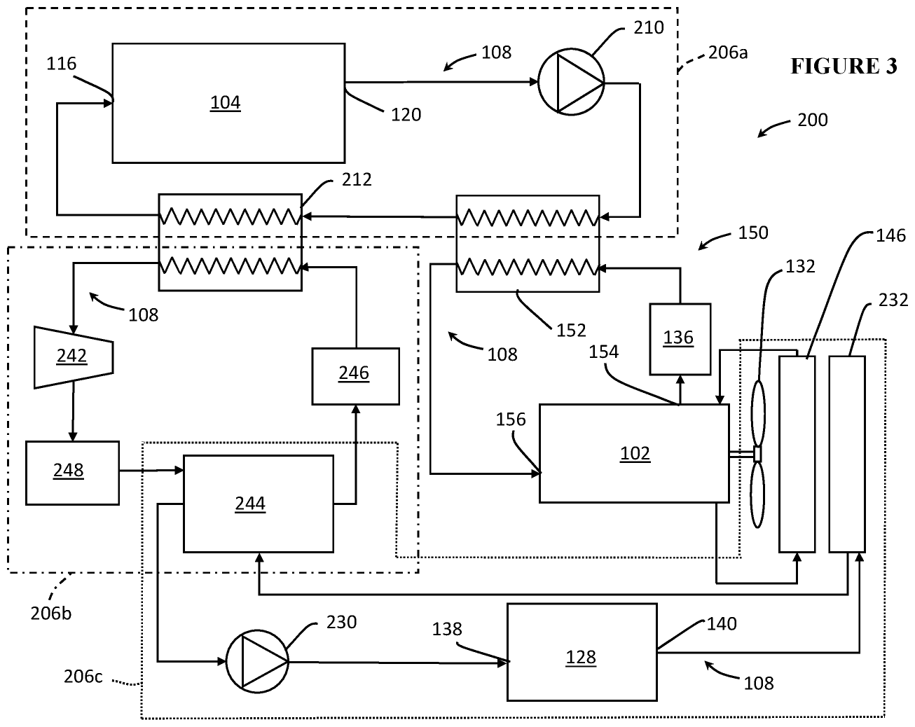

FIG. 3 illustrates a second embodiment of a hybrid thermal management system 200. Similar to the hybrid thermal management system 100 shown in FIG. 1, the hybrid thermal management system 200 shown in FIG. 3 utilizes at least three heat transfer, or cooling, circuits 206a-c, each circuit 206a-c using a different heat transfer fluid or medium (referred to herein a cooling fluid). Thus, the thermal management system 200 shown in FIG. 3 can have benefits similar to those discussed above with respect to the thermal management system 100 shown in FIG. 1. Further, similar to the thermal management system 100 discussed above, while the thermal management system 200 shown in FIG. 3 has three cooling circuits 206a-c, the system 200 can also include more cooling circuits that may, or may not, be related to other systems of a motorized machine or equipment. For example, the thermal management system 200 can also have one or more additional cooling circuits at least similar to the one or more additional cooling circuits 106d discussed above with respect to FIG. 2.

Unlike the thermal management system 100 shown in FIG. 1, the second, or intermediate, cooling circuit 206b of the thermal management system 200 shown in FIG. 3 is the vapor-compression refrigerant circuit or refrigerant, and the third cooling circuit 206c is the conductive fluid cooling circuit. Thus, in the embodiment shown in FIG. 3, heat generated by operation of the battery 106 can be indirectly transferred from the first, dielectric fluid cooling circuit 206a to the third, conductive fluid cooling circuit 206c via the second, or intermediate, vapor-compression refrigerant circuit 206b.

Accordingly, similar to the above discussed first cooling circuit 106a shown in FIG. 1, the first cooling circuit 206a is a dielectric coolant fluid coolant circuit, or a battery cooling circuit, that can utilize the above-discussed dielectric thermal fluid for the first cooling fluid. Moreover, the first cooling fluid that circulates through the first cooling circuit 206a can be a dielectric thermal liquid, and which is not air or another gas. Thus, as with the embodiment discussed above with respect to FIG. 1, the first cooling fluid flowing through the first cooling circuit 206a can be an electrically non-conductive liquid that has a relatively high thermal conductivity and a relatively low viscosity.

The first cooling circuit 206a can have components and arrangements similar to those/that discussed above with respect to the first cooling circuit 106a shown in FIG. 1. Thus, as seen in FIG. 3, the first cooling circuit 206a can include a first pump 210 and one or more first heat exchangers or chillers 212. Again, with such an arrangement, heated first cooling fluid can pass through the coolant outlet 122 of the battery 104 and be circulated via operation of the first pump 210 to pass through at least the first heat exchanger 212. At least a portion of the heat entrained within the first cooling fluid, and, more specifically, entrained in the dielectric thermal fluid, can be transferred at the first heat exchanged 212 to the second cooling fluid, which again, with respect the system 200 shown in FIG. 3, is a refrigerant. The cooled dielectric thermal fluid can then flow to at least the coolant inlet 122 of the battery 104. According to certain embodiments, the first heat exchanger 212, and associated flow of the second cooling fluid therein, can be configured to reduce the temperature of the first cooling fluid to a level that the first cooling fluid can at least assist in maintaining the battery cells, or other cooling fluid or medium within the battery 104, to a temperature of around 10° Celsius (C) to around 40° C.

While not shown, similar to the first cooling circuit 106a shown in FIG. 1, the first cooling circuit 206a can also include one or more of a first fluid reservoir 114, filter 116, and pressure relief valve 118, among other components, that may, or may not, be in positions similar to those shown in FIG. 1.

Similar to the third cooling circuit 106c for the system 100 shown in FIG. 1, the second cooling circuit 206b of the system 200 shown in FIG. 3 is a vapor-compression refrigerant circuit or refrigerant circuit that is adapted to compress a refrigerant that is circulated through the second cooling circuit 206b. Thus, the second cooling circuit 206b can also utilize a refrigerant such as R134a and 2234yf, among other refrigerants.

The second cooling circuit 206b can also include the first heat exchanger 212 such that heat entrained in the first cooling fluid can be transferred to the second cooling fluid via the first heat exchanger 212. Thus, as previously mentioned, according to the illustrated embodiment, the first heat exchanger 212 can be utilized to decrease the temperature of the first cooling fluid and increase the temperature of the second cooling fluid, or refrigerant. Moreover, according to the illustrated embodiment, the cooled second cooling fluid is at least partially heated by the transfer of heat to the second cooling fluid at the first heat exchanger 212, before the at least partially heated second cooling fluid is delivered to the electronic unit 128. Thus, the second cooling fluid delivered to the electronic unit 128 can have a temperature that is higher than a temperature of the second cooling fluid that is delivered to the first heat exchanger 112.

The illustrated second cooling circuit 206b can also include a compressor 242 and a condenser 244. As shown, the heating of the second cooling fluid via use of the first heat exchanger 212 can result in the second cooling fluid being converted from a liquid to a low pressure gas. The low pressure gas can then be compressed by the compressor 242, wherein the heated second cooling fluid is converted to a high pressure gas. The second cooling fluid can then flow to the condenser 244, wherein heat can be removed from the high pressure gaseous second cooling fluid, thereby allowing the gaseous second cooling fluid to return to a liquid state. Further, according to certain embodiments, the condenser 244, heated second cooling fluid can be cooled at the condenser 244 via use of the cooled third cooing fluid.

As with the compressor 142 of thermal management system 100 shown in FIG. 1, the compressor 242 of the thermal management system 200 shown in FIG. 2 can control the cooling of the thermal management system 200. Such control of the thermal management system 200 by the compressor 242 can be similar to that discussed above with respect to the compressor 142 of the system 100 shown in FIG. 1.

Optionally, or additionally, similar to the third cooling circuit 106 shown in FIG. 1, the second cooling circuit 206b shown in FIG. 3 can also include one or more valves 246 and a filter dryer 248. According to certain embodiments, the valve 246 can be an expansion valve or a solenoid valve. Further, the filter dryer 248 can be configured to capture particulate contaminants that may be contained in the second cooling fluid, as well as capture moisture in the second cooling fluid. Additionally, as seen in FIG. 3, according to the illustrated embodiment, the filter dryer 248 can be positioned between the compressor 242 and the condenser 244, and the valve 246 can be positioned between the condenser 244 and the first heat exchanger 212.

Similar to the second cooling fluid utilized with the second cooling circuit 106b discussed above with respect to the system 100 shown in FIG. 1, the third cooling circuit 206c can utilize a third cooling fluid that is electrically conductive, particularly relative to the first cooling fluid. Thus, the third cooling fluid can, for example, include either, or a mixture of, water and glycol, among other conductive fluids. Thus, the third cooling fluid can, for example, be a water and/or glycol based cooling liquid. The third cooling circuit 206c of the system 200 shown in FIG. 3 can therefore be referred to as a conductive fluid cooling circuit.

In addition to including the second heat exchanger 224, the third cooling circuit 206c can further include one or more electronic units 128 that can be similar to that/those discussed above with respect to the system 100 shown in FIG. 1. The third cooling circuit 206c can also include a second pump 230 and a coolant circuit radiator 232. According to certain embodiments, the coolant circuit radiator 232, as well as a radiator 146 of the engine 102, can be cooled by a flow of air that is being circulated by fan 132 that is rotated via operation of the engine 102. Thus, according to certain embodiments, the coolant circuit radiator 232 can be air cooled.

According to the illustrated embodiments, heated third cooling fluid can be circulated via operation of the second pump 230. Such circulation can include the third cooling fluid flowing either, or both, flowing through or around the electronic unit 128 before passing through the coolant outlet 140 of the electronic unit 128. The heated third cooling fluid can then flow on towards the coolant circuit radiator 232. A flow of air that is circulated by operation of the fan 132 can flow either, or both, around or through the coolant circuit radiator 232 to remove heat from the third cooling fluid. The cooled third cooling fluid can then pass through the second heat exchanger 244 so as to absorb at least a portion of heat from the second cooling fluid, before being delivered to the coolant inlet 138 of the electronic unit 128. Therefore, the third cooling fluid is at least partially heated via the heat exchange at the second heat exchanger 244 before the third cooling fluid is delivered to the electronic unit 128. Moreover, the third cooling fluid entering the second heat exchanger 244 can have a temperature that is lower than the temperature of the third cooling fluid that enters the electronic unit 128.

Thus, according to the arrangement of the system 200 depicted in FIG. 3, heat from the battery 104 can be transferred to the first, dielectric cooling fluid before being transferred to the second, refrigerant cooling fluid, and subsequently transferred to the third, conductive cooling fluid.

Additionally, as seen in FIG. 3, and similar to the exemplary system 100 shown in FIG. 1, the illustrated thermal management system 200 can also include a heat circuit 150. Thus, the system 150 shown in FIG. 3 can have an arrangement, and similar components, as discussed above with respect to FIG. 1.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A thermal management system comprising:
a first cooling circuit configured to circulate a first cooling fluid, the first cooling fluid comprising a dielectric thermal fluid, the first cooling circuit including one or more batteries;
a second cooling circuit configured to circulate a second cooling fluid, the second cooling circuit being directly thermally coupled to the first cooling circuit such that a heat entrained in the first cooling fluid is transferable to the second cooling fluid; and
a third cooling circuit configured to circulate a third cooling fluid, the third cooling circuit being directly thermally coupled to the second cooling circuit such that a heat entrained in the second cooling fluid is transferable to the third cooling fluid,
wherein the second cooling fluid is one of an electrically conductive cooling fluid or a refrigerant, the third cooling fluid being the other of the electrically conductive cooling fluid and the refrigerant.

2. The thermal management system of claim 1, wherein the second cooling fluid is the electrically conductive cooling fluid and the third cooling fluid is the refrigerant, and wherein the second cooling circuit further includes at least one electronic unit that is electrically coupled to the one or more batteries.

3. The thermal management system of claim 2, wherein the at least one electronic unit comprises at least one inverter.

4. The thermal management system of claim 2, further including:
a first heat exchanger and a second heat exchanger, the first heat exchanger being fluidly coupled to the first and second cooling circuits, the second heat exchanger being fluidly coupled to the second and third cooling circuits, and
wherein a temperature of the second cooling fluid outputted from the at least one electronic unit is reduced at the second heat exchanger before the second cooling fluid is circulated to the first heat exchanger, the temperature of the second cooling fluid being increased at the first heat exchanger before the second cooling fluid is delivered to the at least one electronic unit.

5. The thermal management system of claim 2, wherein the second cooling circuit does not include a radiator and wherein the third cooling circuit includes a compressor and a condenser.

6. The thermal management system of claim 5, wherein the condenser is positioned to be air cooled via at least operation of a fan that is coupled to a diesel engine.

7. The thermal management system of claim 5, wherein an activation and a deactivation of the thermal management system is controlled via a control of a supply of electrical power to the compressor.

8. The thermal management system of claim 5, wherein the first cooling circuit and the at least one electronic unit are housed together within a housing, the housing not including at least the compressor of the third cooling circuit.

9. The thermal management system of claim 1, wherein the second cooling fluid is the refrigerant, wherein the third cooling fluid is the electrically conductive cooling fluid, and wherein the third cooling circuit further includes at least one electronic unit that is electrically coupled to the one or more batteries.

10. The thermal management system of claim 9, wherein the at least one electronic unit is at least one inverter.

11. The thermal management system of claim 9, wherein the heat entrained in the first cooling fluid is transferred from the first cooling fluid to the second cooling fluid at a first heat exchanger, and the heat entrained in the second cooling fluid is transferred from the second cooling fluid to the third cooling fluid at a second heat exchanger and wherein a temperature of the third cooling fluid outputted from the at least one electronic unit is reduced at a coolant circuit radiator of the third cooling circuit before the temperature of the third cooling fluid is elevated at the second heat exchanger and circulated to the at least one electronic unit.

12. The thermal management system of claim 11, wherein the coolant circuit radiator is positioned to be cooled via at least operation of a fan of a diesel engine.

13. A thermal management system comprising:
a hybrid diesel engine;
at least one electronic unit;
at least one battery;
a first cooling circuit configured to circulate a first cooling fluid, the first cooling fluid comprising a dielectric thermal fluid, the first cooling circuit positioned to remove heat from the at least one battery;
a second cooling circuit configured to circulate a second cooling fluid, the second cooling circuit being directly thermally coupled to the first cooling circuit such that heat entrained in the first cooling fluid is absorbed by the second cooling fluid; and
a third cooling circuit configured to circulate a third cooling fluid, the third cooling circuit being directly thermally coupled to the second cooling circuit such that heat entrained in the second cooling fluid is absorbed by the third cooling fluid,
wherein the second cooling fluid is one of an electrically conductive cooling fluid or a refrigerant, the third cooling fluid being the other of the electrically conductive cooling fluid and the refrigerant,
wherein the second cooling circuit or the third cooling circuit is positioned to remove heat from the at least one electronic unit, and
wherein a portion of the second cooling circuit or the third cooling circuit is positioned to be air cooled by a fan that is operable by the hybrid diesel engine.

14. The thermal management system of claim 13, wherein the second cooling fluid is the electrically conductive cooling fluid, wherein the third cooling fluid is the refrigerant, and wherein the second cooling circuit is positioned to remove heat from the at least one electronic unit.

15. The thermal management system of claim 14, further including:
a first heat exchanger and a second heat exchanger, the first heat exchanger being fluidly coupled to the first cooling circuit and second cooling circuit, the second heat exchanger being fluidly coupled to the second cooling circuit and third cooling circuit,
wherein a temperature of the second cooling fluid outputted from the at least one electronic unit is reduced at the second heat exchanger before the second cooling fluid is circulated to the first heat exchanger, the temperature of the second cooling fluid being increased at the first heat exchanger before the second cooling fluid is delivered to the at least one electronic unit.

16. The thermal management system of claim 15, wherein the second cooling circuit does not include a radiator.

17. The thermal management system of claim 13, wherein the first cooling circuit and the at least one electronic unit are housed together within a housing, the housing not including at least a compressor of the third cooling circuit.

18. The thermal management system of claim 17, wherein an activation and a deactivation of the thermal management system is controlled by a supply of electrical power to the compressor.

19. The thermal management system of claim 13, wherein the second cooling fluid is the refrigerant, wherein the third cooling fluid is the electrically conductive cooling fluid, and wherein the third cooling circuit is positioned to remove heat from the at least one electronic unit.

20. The thermal management system of claim 19, wherein heat is transferred from the first cooling fluid to the second cooling fluid at a first heat exchanger, wherein heat is transferred from the second cooling fluid to the third cooling fluid at a second heat exchanger, and wherein a temperature of the third cooling fluid outputted from the at least one electronic unit is reduced at a coolant circuit radiator of the third cooling circuit before the temperature of the third cooling fluid is elevated at the second heat exchanger and circulated to the at least one electronic unit.
